(19) United States
(12) Patent Application Publication
(10) Pub. No.: US 2026/0328334 A1
(43) Pub. Date: Oct. 22, 2026

(54) MOTORIZED MECHANISM FOR TRANSLATION ADJUSTMENT

(71) Applicant: ZHONGSHAN UNITED OPTOELECTRONIC DISPLAY TECHNOLOGY CO., LTD., Zhongshan (CN)

(72) Inventors: Canjun WANG, Zhongshan (CN); Zhongjie LI, Zhongshan (CN); Qinhe RAO, Zhongshan (CN)

(73) Assignee: ZHONGSHAN UNITED OPTOELECTRONIC DISPLAY TECHNOLOGY CO., LTD., Zhongshan (CN)

(21) Appl. No.: 19/211,496

(22) Filed: May 19, 2025

(30) Foreign Application Priority Data
Apr. 16, 2025 (CN) 202510478648.8

(51) Int. Cl. F16M 11/04; G01D 5/16; G03B 21/14

(52) U.S. Cl. CPC F16M 11/045; F16M 11/046; F16M 11/048; G03B 21/142; G01D 5/16; G01D 2205/10

(57) ABSTRACT

A motorized mechanism for translation adjustment includes a base plate, a cover plate, a movable plate and a position detection device. The cover plate is fixedly connected to the base plate, and a through hole is formed in the middle of the cover plate to allow the projector to move in translation. The movable plate is movably provided between the base plate and the cover plate along a plane parallel to the base plate, so as to drive the projector connected to the movable plate to move along a plane parallel to the base plate. The position detection device is configured to detect the moving position of the movable plate.

### CROSS-REFERENCE TO RELATED APPLICATIONS

The present application claims priority to Chinese Patent Application No. 202510478648.8, filed on Apr. 16, 2025, the entire contents of which are incorporated herein by reference.

### TECHNICAL FIELD

The present application relates to the technical field of projector image adjustment, and in particular to a motorized mechanism for translation adjustment.

### BACKGROUND

At present, the adjustment of the projector image generally requires moving the entire projector to achieve the adaptation of the image to the screen. After the placement of the projector is fixed, the projected image cannot be moved anymore, that is, when there is no position for the projector to move, the projected image cannot be moved anymore, causing great inconvenience to the user. Moreover, when the projector is adjusted, there is a lack of detection of the specific position of the projector.

### SUMMARY

The present application is to provide a motorized mechanism for translation adjustment, which is intended to conveniently and accurately adjust the projected image of the projector.

To achieve the above-mentioned purpose, the motorized mechanism for translation adjustment proposed in the present application includes a base plate, a cover plate, a movable plate and a position detection device.

The cover plate is fixedly connected to the base plate, and a through hole is formed in a middle of the cover plate and is configured to allow the projector to move in translation.

The movable plate is movably provided between the base plate and the cover plate along a plane parallel to the base plate, and is configured to drive the projector connected to the movable plate to move along the plane parallel to the base plate.

The position detection device is configured to detect a moving position of the movable plate.

In an embodiment, the position detection device includes a tunnel magnetoresistive (TMR) magnetic group induction chip component and a magnet.

The tunnel magnetoresistive (TMR) magnetic group induction chip component is provided at the cover plate or the base plate.

The magnet is provided at the movable plate and corresponds to the TMR magnetic group induction chip component in an up-down direction, and is configured to allow the TMR magnetic group induction chip component to detect a moving stroke of the magnet.

In an embodiment, the position detection device includes four optical coupling sensor components, the four optical coupling sensor components are respectively provided at two ends of the cover plate in a front-back direction and two ends of the cover plate in a left-right direction, correspond to two ends of the movable plate in a front-back direction and two ends of the movable plate in a left-right direction, and are configured to detect limit positions of front-back and left-right moving range of the movable plate.

In an embodiment, the motorized mechanism for translation adjustment further includes a drive structure, and the drive structure includes a stepper motor configured to drive the movable plate to move along the plane parallel to the base plate.

In an embodiment, the movable plate includes a first movable plate configured connect with the projector.

The stepper motor includes a first stepper motor, the first stepper motor includes first output shaft extending in a left-right direction, and a first drive gear is provided at the first output shaft.

The drive structure further includes a front-back drive structure, and the front-back drive structure includes a first transmission gear, a second transmission gear, a third transmission gear, a second drive gear and a longitudinal limit structure.

The first transmission gear is rotatably fixed to a side wall of the cover plate in the left-right direction along an axis in the left-right direction and is meshed with the first drive gear.

The second transmission gear is rotatably fixed to a side wall of the base plate in the left-right direction along the axis in the left-right direction. The first drive gear, the first transmission gear and the second transmission gear are meshed in sequence, and a number of teeth increases in sequence.

The third transmission gear is coaxially connected to the second transmission gear.

The second drive gear is rotatably mounted at a side wall of the base plate along the axis in the left-right direction and is meshed with the third transmission gear.

The longitudinal limit structure is configured to limit a movement of the first movable plate in an up-down direction.

A first drive groove is provided at the second drive gear, and the side wall of movable plate in the left-right direction is protruded with a first drive boss configured to cooperate with the first drive groove.

In an embodiment, the first drive groove is elliptical and is configured to extend radially along the second drive gear, the limit boss is a cylinder, and the second drive gear is a sector gear.

In an embodiment, the motorized mechanism for translation adjustment further includes a synchronous transmission device. The synchronous transmission device includes a bracket, a guide rod, a first synchronous gear, a second synchronous gear and a third drive gear.

The bracket is fixedly connected to the cover plate.

The guide rod is configured to extend in the left-right direction and is rotatably provided at the bracket.

The first synchronous gear is provided at one end of the guide rod and is meshed with the second drive gear.

The second synchronous gear is provided at the other end of the guide rod.

The third drive gear is rotatably mounted at the other side wall of the base plate and is meshed with the second synchronous gear. The third drive gear is provided with a second drive groove, and a second drive boss configured to cooperate with the second drive groove is provided to protrude from the other side wall of the movable plate in the left-right direction.

In an embodiment, the movable plate further includes a second movable plate, second movable plate is movably provided between the first movable plate and the base plate in the left-right direction and is fixedly connected to the first movable plate.

The second movable plate is provided with a third drive boss protruding downward, and the third drive boss is provided with a left-right threaded hole along the left-right direction.

The stepper motor includes a second stepper motor, the second stepper motor includes a second output shaft configured to extend in the left-right direction, and a fourth drive gear is provided at the second output shaft.

The drive structure further includes a left-right drive structure, and the left-right drive structure includes a lead screw and a fifth drive gear.

The lead screw is at least partially provided with threads and is configured to cooperate with the threaded hole.

The fifth drive gear is sleeved at the lead screw and is configured to drive the lead screw to rotate along the axis in the left-right direction.

The fifth drive gear is meshed with the fourth drive gear through at least one transmission gear, and the lead screw is configured to drive the third drive boss to move in the left-right direction during rotation along the axis in the left-right direction.

In an embodiment, the base plate is provided with a limit hole in the up-down direction, the limit hole is configured to extend in a front-back direction, and a limit boss is provided to protrude from a bottom surface of the movable plate in the up-down direction to cooperate with the limit hole.

And/or the base plate is formed with a limit groove extending in the left-right direction corresponding to the third drive boss, and the third drive boss is provided in the limit groove.

In an embodiment, an upper end surface of the base plate is provided with a positioning column protruding upward, and a threaded hole is provided in an upper end surface of the positioning column along an up-down direction and is threaded to the cover plate.

In the technical solution of the present application, the motorized mechanism for translation adjustment includes a base plate, a cover plate, a movable plate and a position detection device. The cover plate is fixedly connected to the base plate, and a through hole is formed in the middle of the cover plate for the projector to make way for translation. The movable plate is movably provided between the base plate and the cover plate along a plane parallel to the base plate, so as to drive the projector connected to the movable plate to move along a plane parallel to the base plate. The position detection device is used to detect the moving position of the movable plate. By adjusting the position of the movable plate, the position of the projector is adjusted, then the image of the projector is adjusted, so as to avoid directly adjusting the projector, and the adjusted projector can be effectively fixed by the movable plate provided between the base plate and the cover plate. The position of the movable plate is detected in real time by the position detection device, so as to facilitate recording and the next adjustment. In addition, when it is detected that the moving distance of the movable plate exceeds the predetermined range, adjustments can also be made in time to increase the reliability of the mechanism.

### BRIEF DESCRIPTION OF THE DRAWINGS

In order to more clearly illustrate the technical solutions in the embodiments of the present application or in the related art, the accompanying drawings required for use in the description of the embodiments or the related art will be briefly introduced below. Obviously, the drawings described below are only some embodiments of the present application. For persons skilled in the art, other drawings can be obtained based on the structures shown in these drawings without paying creative efforts.

FIG. 1 is a schematic structural view of a motorized mechanism for translation adjustment according to an embodiment of the present application.

FIG. 2 is an exploded view of the motorized mechanism for translation adjustment in FIG. 1.

FIG. 3 is a schematic structural view of the motorized mechanism for translation adjustment in FIG. 1 from another perspective.

FIG. 4 is an exploded view of the motorized mechanism for translation adjustment in FIG. 1 including a left-right drive structure.

FIG. 5 is an exploded view of the motorized mechanism for translation adjustment in FIG. 1 including the left-right drive structure from another perspective.

FIG. 6 is a schematic structural view of a bottom surface of the motorized mechanism for translation adjustment in FIG. 1.

The realization of the purpose, functional features and advantages of the present application will be further explained in conjunction with embodiments and with reference to the accompanying drawings.

### DETAILED DESCRIPTION OF THE EMBODIMENTS

The following will be combined with the drawings to clearly and completely describe the technical solutions in the embodiments of the present application. Obviously, the described embodiments are only part of the embodiments of the present application, not all of the embodiments. Based on the embodiments of the present application, all other embodiments obtained by persons skilled in the art without creative efforts are within the scope of the present application.

It should be noted that if the embodiments of the present application involve directional indications (such as up, down, left, right, front, back, etc.), the directional indications are only used to explain the relative position relationship, movement status, etc. between the components in a certain specific posture. If the specific posture changes, the directional indication will also change accordingly.

In addition, if there are descriptions involving “first”, “second”, etc. in the embodiments of the present application, the descriptions of “first”, “second”, etc. are only used for descriptive purposes and cannot be understood as indicating or implying their relative importance or implicitly indicating the number of technical features indicated. Therefore, the features limited to “first” and “second” may explicitly or implicitly include at least one of the features. In addition, if “and/or” appears in the full text, its meaning includes three parallel solutions. Taking “A and/or B” as an example, it includes solution A, solution B, or solutions that satisfy both A and B. In addition, the technical solutions between the various embodiments can be combined with each other, but it must be based on the ability of persons skilled in the art to implement. When the combination of technical solutions is contradictory or cannot be implemented, it should be deemed that such combination of technical solutions does not exist and is not within the scope of the present application.

The present application provides a motorized mechanism 100 for translation adjustment.

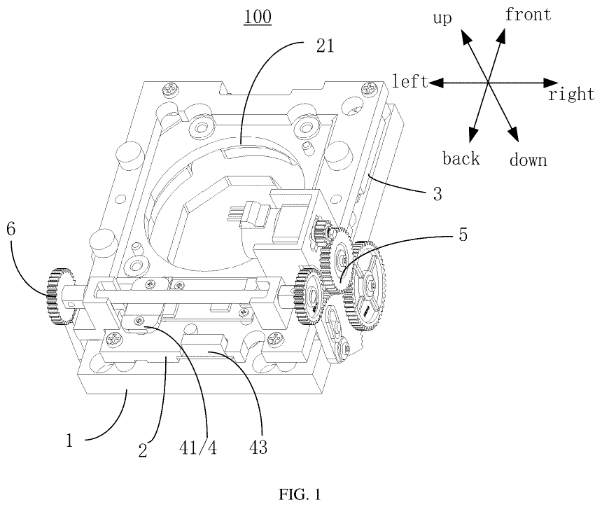

As shown in FIG. 1, in an embodiment of the present application, the motorized mechanism 100 for translation adjustment includes a base plate 1, a cover plate 2, a movable plate 3 and a position detection device 4. The cover plate 2 is fixedly connected to the base plate 1. A through hole 21 is formed in the middle of the cover plate 2 for facilitating translation of the projector. The movable plate 3 is movably provided between the base plate 1 and the cover plate 2 along a plane parallel to the base plate 1 to drive the projector connected to the movable plate 3 to move along a plane parallel to the base plate 1. The position detection device 4 is used to detect the moving position of the movable plate 3.

In the technical solution of the present application, the motorized mechanism 100 for translation adjustment includes a base plate 1, a cover plate 2, a movable plate 3 and a position detection device 4. The cover plate 2 is fixedly connected to the base plate 1, and a through hole 21 is formed in the middle of the cover plate 2 for the projector to translate and make way. The movable plate 3 is movably provided between the base plate 1 and the cover plate 2 along a plane parallel to the base plate 1, and is used to drive the projector connected to the movable plate 3 to move along a plane parallel to the base plate 1. The position detection device 4 is used to detect the moving position of the movable plate 3. By adjusting the position of the movable plate 3, the position of the projector is adjusted, and then the image of the projector is adjusted, so as to avoid directly adjusting the projector, and the adjusted projector can be effectively fixed by the movable plate 3 provided between the base plate 1 and the cover plate 2. The position of the movable plate 3 is detected in real time by the position detection device 4, which is convenient for recording and the next adjustment. In addition, when it is detected that the moving distance of the movable plate 3 exceeds the predetermined range, adjustments can also be made in time to increase the reliability of the mechanism.

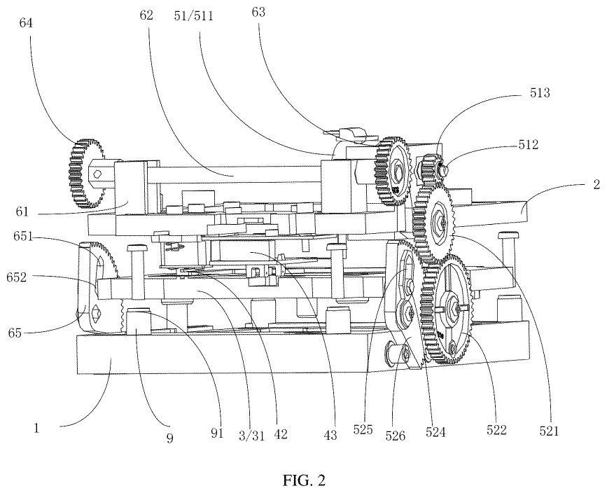

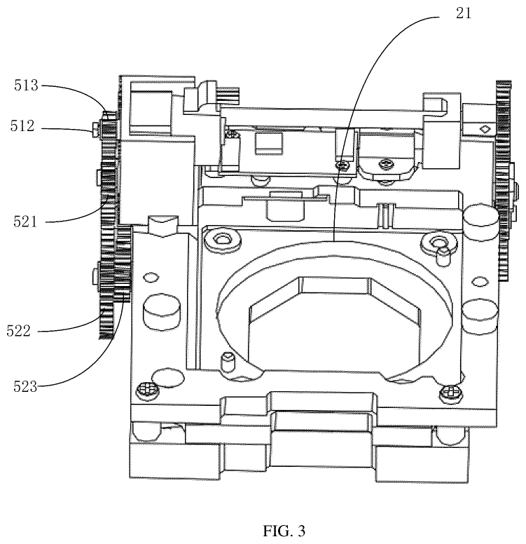

It can be understood that there are many ways for the movable plate 3 to be movable. It can be that a guide rail extending in the front-back direction or the left-right direction is provided between the cover plate 2 and the base plate 1, and the movable plate 3 is clamped in the guide rail, so that the movable plate 3 moves along the guide rail under the drive of manual or other external forces. In an embodiment, as shown in FIG. 2 and FIG. 3, a drive structure 5 can also be provided, and the drive structure includes a stepper motor 51, so as to drive the movable plate 3 to move in the front-back direction or the left-right direction. By using the stepper motor 51 to drive the movable plate 3, compared with manual adjustment, while saving manpower, the amplitude of each adjustment can be accurately controlled, and it is easier to achieve an ideal projection effect. It can be understood that in order to more accurately control the movable plate 3, the stepper motor 51 can also be adaptively replaced with a servo motor, so as to achieve more accurate control in some cost-insensitive occasions.

Specifically, there are many ways for the stepper motor 51 to drive the movable plate 3. For example, a crank connecting rod mechanism may be connected to the output shaft of the stepper motor 51, the output shaft of the stepper motor 51 is rotatably connected to the crank, and the connecting rod is connected to the movable plate 3, thereby driving the movable plate 3 to move forward and backward. The crank connecting rod mechanism may also be adaptively replaced with a ball screw structure, and the present application is not limited thereto, as long as the rotation can be converted into linear motion.

In an embodiment of the present application, as shown in FIG. 2 and FIG. 3, the movable plate 3 includes a first movable plate 31 for connecting with the projector. The stepper motor includes a first stepper motor 511, the first stepper motor 511 includes a first output shaft 512 extending in the left-right direction, and a first drive gear 513 is provided at the first output shaft 512. The drive structure also includes a front-back drive structure 52, and the front-back drive structure 52 includes a first transmission gear 521, a second transmission gear 522, a third transmission gear 523, a second drive gear 524 and a longitudinal limit structure. The first transmission gear 521 is rotatably fixed to the side wall of the cover plate 2 in the left-right direction along the axis in the left-right direction. The second transmission gear 522 is rotatably fixed to the side wall of the base plate 1 in the left-right direction along the axis in the left-right direction. The first drive gear 513, the first transmission gear 521 and the second transmission gear 522 are meshed one by one in sequence, and the number of teeth increases in sequence. The third transmission gear 523 is coaxially connected with the second transmission gear 522. The second drive gear 524 is rotatably mounted at the side wall of the base plate 1 along the axis in the left-right direction, and meshes with the third transmission gear 523. The longitudinal limit structure is used to limit the movement of the first movable plate 31 in the up-down direction. The second drive gear 524 is provided with a first drive groove 525, and a first drive boss 526 that matches the first drive groove 525 is provided to protrude from the side wall of the first movable plate 31 in the left-right direction. It can be understood that according to the law of conservation of energy, the input power P1 of the driving gear is equal to the output power P2 of the driven gear, that is, P1=P2, and the power P=Tω, so T1ω1=T2ω2. From ω1r1=ω2r2, we can get ω1/ω2=r2/r1. By substituting ω1/ω2=r2/r1 into T1ω1=T2ω2, we get T2/T1=r2/r1. This shows that the ratio of the torque T2 of the driven gear to the torque T1 of the driving gear is equal to the ratio of the radius r2 of the driven gear to the radius r1 of the driving gear. That is, in a gear set, the torque is proportional to the gear radius/number of teeth. In order to better drive the first movable plate 31 to move, the first transmission gear 521 and the second transmission gear 522 with increasing numbers of teeth are provided, which reduces the transmission pressure and amplifies the torque of the stepper motor. In addition, by arranging the gears in sequence from top to bottom, the space occupied in the left-right direction is effectively saved. By providing a first drive groove 525 at the second drive gear 524, the first drive groove 525 rotates with the second drive gear 524, and drives the first movable plate 31 to move through the first drive boss 526. However, by providing a longitudinal limit structure to limit the movement of the first movable plate 31 in the up-down direction, the first movable plate 31 only synchronizes the displacement of the second drive gear 524 in the front-back direction.

The longitudinal limit structure may be a limit plate extending from the side wall of the cover plate 2 or the base plate 1 in the left-right direction toward the first drive boss 526, and a limit straight groove extending in the front-back direction is provided at the position corresponding to the first drive boss 526, so as to allow the first drive boss 526 to pass through and limit its movement in the front-back direction. Alternatively, a second limit straight groove extending in the front-back direction is provided at the side of the cover plate 2 or the base plate 1 facing the first movable plate 31, and a slider that is clamped in the second limit straight groove or a ball that can roll in the second limit straight groove is provided to protrude from the first movable plate 31 to limit its movement in the up-down direction. The present application does not limit the specific structure of the longitudinal limit structure, as long as it can limit its movement in the up-down direction.

The third transmission gear 523 is coaxially connected with the second transmission gear 522. The second drive gear 524 is rotatably mounted at the side of the base plate 1. The second drive gear 524 is provided with a first drive groove 525. The other side wall of the first movable plate 31 is provided with a first drive boss 526 that cooperates with the first drive groove 525 along the left-right direction.

The first drive groove 525 can extend radially along the second drive gear 524, or can extend radially away from the second drive gear 524 to obtain different forward and backward moving speeds. Specifically, in an embodiment of the present application, the first drive groove 525 is an elliptical groove and extends radially along the second drive gear 524, the limit boss 8 is a cylinder, and the second drive gear 524 is a fan-shaped gear, which reduces the pressure on the first drive boss 526, reduces wear, and increases the service life. In addition, it can be understood that since the moving distance of the first movable plate 31 is not long, and the rotation amplitude of the second drive gear 524 is not large, it is not necessary for all gears to participate in the transmission. For this reason, the second drive gear 524 is set as a fan-shaped gear, thereby further saving space. The present application does not limit the size of the central angle of the fan-shaped gear, and it can be changed according to actual needs.

It can be understood that, if the movable plate 3 is driven to move by only one drive boss, the movable plate 3 is subjected to a unilateral force and is easily deflected by torque, which affects the accuracy of forward and backward movement and causes damage to the movable plate 3. For this reason, in an embodiment of the present application, the motorized mechanism 100 for translation adjustment further includes a synchronous transmission device 6, including a bracket 61, a guide rod 62, a first synchronous gear 63, a second synchronous gear 64 and a third synchronous gear. The bracket 61 is fixedly connected to the cover plate 2, and the guide rod 62 extends in the left-right direction and is rotatably provided at the bracket 61. The first synchronous gear 63 is provided at one end of the guide rod 62 and meshes with the second drive gear 524. The second synchronous gear 64 is provided at the other end of the guide rod 62. The third drive gear 65 is rotatably mounted at the other side of the base plate 1 and meshes with the second synchronous gear 64. A second drive groove 651 is provided at the third drive gear 65, and a second drive boss 652 cooperating with the drive groove is provided to protrude from the other side wall of the movable plate 3 in the left-right direction. By such arrangement, the other side wall of the movable plate 3 in the left-right direction is also subjected to the driving force in the front-back direction, thereby balancing the torque, improving the precision of the front-back movement, and protecting the movable plate 3. Specifically, the third drive gear 65, the second drive groove 651, and the second drive boss 652 can all be configured to be the same as the second drive gear 524, the first drive groove 525, and the first drive boss 526.

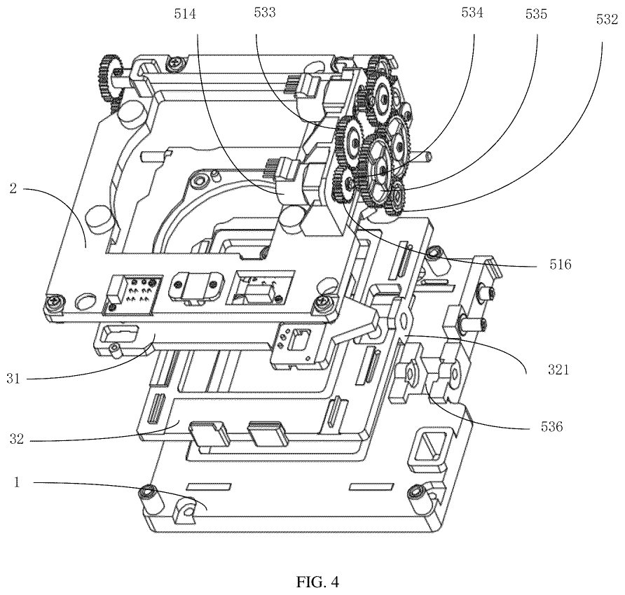

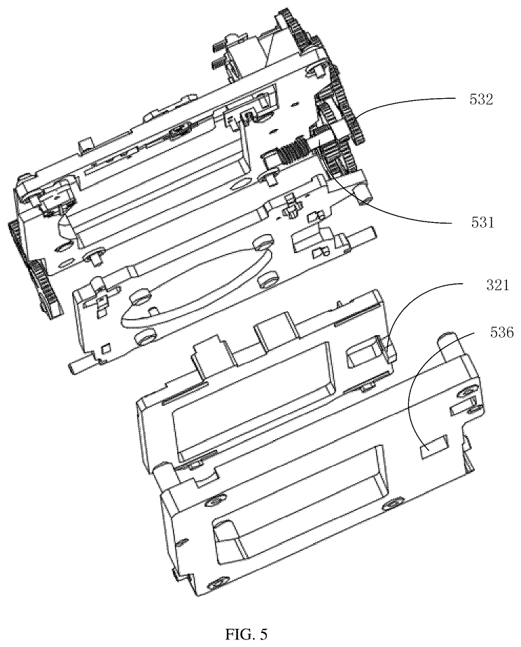

In addition, in order to increase the adjustment range of the projector and meet the demand for precise left-right adjustment, in an embodiment of the present application, as shown in FIG. 4 and FIG. 5, the movable plate 3 also includes a second movable plate 32, which is movably provided between the first movable plate 31 and the base plate 1 along the left-right direction, and is fixedly connected to the first movable plate 31. The second movable plate 32 is provided with a third drive boss 321 protruding downward, and the third drive boss 321 is provided with a left-right threaded hole in the left-right direction. The stepper motor includes a second stepper motor 514, and the second stepper motor 514 includes a second output shaft 515 and a fourth drive gear 516. The drive structure also includes: a left-right drive structure 53, and the left-right drive structure 53 includes a lead screw 531, at least a portion of which is provided with threads and cooperates with the left-right threaded hole; a fifth drive gear 532, which is sleeved on the lead screw 531 and is used to drive the lead screw 531 to rotate along the axis in the left-right direction. The fifth drive gear 532 is meshed with the fourth drive gear 516 through at least one transmission gear, and the lead screw 531 drives the second movable plate 32 to move along the left-right direction during the process of rotating along the axis in the left-right direction.

By such arrangement, the second stepper motor 514 drives the lead screw 531 to rotate along the axis in the left-right direction, and the lead screw 531 and the left-right threaded holes form a ball screw structure, thereby converting the rotation of the lead screw 531 into the linear motion of the third drive boss 321 along the left-right direction. This, in turn, drives the second movable plate 32 to move in the left-right direction. Since the second movable plate 32 is fixedly connected to the first movable plate 31, it finally drives the first movable plate 31 and the projector to move in the left-right direction. By providing the second movable plate 32 and the left-right drive structure 53, the first movable plate 31 and the second movable plate 32 are respectively responsible for translation in two directions, realizing the requirement of free adjustment in all directions parallel to the plane of the base plate 1, and improving the adjustment flexibility. It should be noted that when the second movable plate 32 drives the first movable plate 31 to move in the left-right direction, the first drive boss 526 and the second drive boss 652 move in the left-right direction in the first drive groove 525 and the second drive groove 651 respectively. For this purpose, the first drive boss 526 and the second drive boss 652 can be lengthened respectively to prevent them from falling out of the grooves.

In addition, by providing at least one transmission gear, while improving the transmission pressure, since the fifth drive gear 532 and the fourth drive gear 516 do not need to be directly meshed, the installation positions of the second stepper motor 514 and the lead screw 531 are more flexible, and other devices inside the motorized mechanism for translation adjustment 100 can be avoided, which is convenient for the overall design of the device. It can be understood that the present application does not limit the specific installation position and number of the at least one transmission gear, which can be changed according to actual needs. In this embodiment, the at least one transmission gear includes a fourth transmission gear 533, a fifth transmission gear 534 and a sixth transmission gear 535. The fourth transmission gear 533 is rotatably fixed to the side wall of the cover plate 2 in the left-right direction along the axis in the left-right direction, and meshes with the fourth drive gear 516. The fifth transmission gear 534 is rotatably fixed to the side wall of the cover plate 2 in the left-right direction along the the axis in the left-right direction, and meshes with the fourth transmission gear 533. The sixth transmission gear 535 is coaxially connected to the fifth transmission gear 534 and meshes with the fifth drive gear 532. In this way, the second stepper motor 514 and the lead screw 531 can be respectively provided above and below the motorized mechanism for translation adjustment 100, which is convenient for the overall design of the device. In addition, the sixth transmission gear 535 is provided on the outside of the fifth transmission gear 534, so that the fifth drive gear 532 is also provided on the outside of the drive structure, and there is a left-right deviation from the third transmission gear 523, so as to avoid interference with the front-back drive structure 52.

Furthermore, the base plate 1 is formed with a limit groove 536 extending in t left-right direction corresponding to the third drive boss 321, and the third drive boss 321 is provided in the limit groove 536. In this way, the moving distance of the second movable plate 32 is limited to prevent the projector on the first movable plate 31 from interfering with the cover plate 2 and causing damage to the projector.

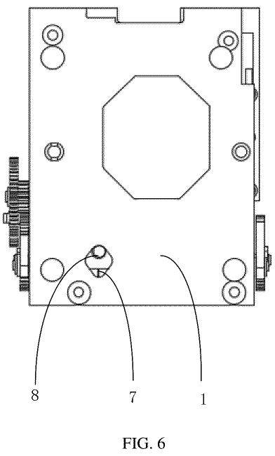

In an embodiment of the present application, as shown in FIG. 6, the base plate 1 is provided with a limit hole 7 in the up-down direction, the limit hole 7 extends in the front-back direction, and the bottom surface of the movable plate 3 is provided with a limit boss 8 in the up-down direction that cooperates with the limit hole 7, so that the moving distance of the movable plate 3 in the front-back direction is limited to prevent the projector on the movable plate 3 from interfering with the cover plate 2 and causing damage to the projector. In addition, it can be understood that when the movable plate 3 is manually adjusted or the above-mentioned left-right drive structure 53 is provided, there will be a need to adjust the movable plate 3 in the left-right direction. For this reason, the limit hole 7 can also extend in the left-right direction to allow the movable plate 3 to move.

Furthermore, in order to reduce the wear between each boss and the above-mentioned holes or grooves, rolling bearings can also be sleeved on the first drive boss 526, the second drive boss 652, and the limit boss 8 to convert their sliding movement with the holes or grooves into rolling movement, thereby reducing wear and increasing service life.

In order to more accurately detect whether the movable plate 3 moves beyond predetermined range, the position detection device 4 also includes four optical coupling sensor components, which are respectively provided at the two ends of the cover plate 2 in the front-back direction and the two ends of the cover plate 2 in the left-right direction, and correspond to the two ends of the movable plate 3 in the front-back direction and the two ends of the movable plate 3 in the left-right direction respectively, so as to detect the limit position of the front, back, left, and right movement ranges of the movable plate 3. It should be noted that the optical coupling sensor component is an electronic component that realizes electrical isolation through optical signals. Its core principle is to convert the electrical signal at the input end into an optical signal through an optical medium, and then restore the optical signal to an electrical signal at the output end, thereby realizing electrical isolation between input and output. In this embodiment, the optical coupling sensor component detects the distance between the movable plate 3 and itself through the optical medium, and compares this distance with a preset value, so as to determine whether the movable plate 3 moves beyond the predetermined range. When one of the two optical coupling sensor components detects that the distance is too close, it can be determined that the movable plate 3 exceeds the moving range, and then the electrical connection is quickly cut off, so that the motorized mechanism for translation adjustment 100 is shut down, which is convenient for timely adjustment and maintenance. Such a setting further improves the degree of electrification, reduces manpower, and increases the reliability of the mechanism.

In addition, in an embodiment of the present application, a positioning column is provided to protrude upward from the upper end surface of the base plate 1, and a threaded hole 91 is provided on the upper end surface of the positioning column 9 in the up-down direction for threaded connection with the cover plate 2. In this way, the base plate 1 and the cover plate 2 can be reliably connected. The present application does not limit the number and layout positions of the positioning columns 9 and the threaded holes 91, and can be changed according to actual needs and space occupancy. In an embodiment, four positioning columns 9 are provided, and are arranged at intervals around the base plate 1 respectively. While the connection is firm, the movable plate 3 can also be prevented from falling out.

In an embodiment of the present application, the position detection device 4 includes a tunnel magnetoresistive (TMR) magnetic group induction chip component and a magnet 42. The TMR magnetic group induction chip component is provided at the cover plate 2 or the base plate 1. The magnet 42 is provided at the movable plate 3 and corresponds to the TMR magnetic group induction chip component in the up-down direction, so that the TMR magnetic group induction chip component can detect the moving stroke of the magnet 42. It should be noted that the TMR magnetic group induction chip component is a high-precision magnetic sensor based on the tunnel magnetoresistance, which has the characteristics of sensitivity, stability and low power consumption, and can accurately detect the movement of the magnet 42. By providing the TMR magnetic group induction chip component, the position of the movable plate 3 can be accurately detected, which is convenient for quick adjustment to the desired position, or by recording the moving position this time, it is convenient to directly adjust it when the same projection distance is reached next time. In addition, when it is detected that the moving distance of the movable plate 3 exceeds the predetermined range, adjustments can also be made in time to increase the reliability of the mechanism.

The above description are only exemplary embodiments of the present application and does not limit the scope of the present application. All equivalent structural changes made by using the contents of the specification and drawings of the present application under the technical concept of the present application, or directly/indirectly applied in other related technical fields, are included in the scope of the present application.

What is claimed is:

1. A motorized mechanism for translation adjustment, applied to a projector, comprising:
a base plate;
a cover plate fixedly connected to the base plate;
a movable plate, movably provided between the base plate and the cover plate along a plane parallel to the base plate, and configured to drive the projector connected to the movable plate to move along the plane parallel to the base plate; and
a position detection device configured to detect a moving position of the movable plate,
wherein a through hole is formed in a middle of the cover plate and is configured to allow the projector to move in translation.

2. The motorized mechanism for translation adjustment according to claim 1, wherein the position detection device comprises:
a tunnel magnetoresistive (TMR) magnetic group induction chip component provided at the cover plate or the base plate; and
a magnet, provided at the movable plate and corresponding to the TMR magnetic group induction chip component in an up-down direction, and configured to allow the TMR magnetic group induction chip component to detect a moving stroke of the magnet.

3. The motorized mechanism for translation adjustment according to claim 1, wherein the position detection device comprises four optical coupling sensor components, the four optical coupling sensor components are respectively provided at two ends of the cover plate in a front-back direction and two ends of the cover plate in a left-right direction, correspond to two ends of the movable plate in a front-back direction and two ends of the movable plate in a left-right direction, and are configured to detect limit positions of front-back and left-right moving range of the movable plate.

4. The motorized mechanism for translation adjustment according to claim 1, further comprising a drive structure, wherein the drive structure comprises a stepper motor configured to drive the movable plate to move along the plane parallel to the base plate.

5. The motorized mechanism for translation adjustment according to claim 4, wherein:
the movable plate comprises a first movable plate configured to connect with the projector;
the stepper motor comprises a first stepper motor, the first stepper motor comprises a first output shaft extending in a left-right direction, and a first drive gear is provided at the first output shaft;
the drive structure further comprises a front-back drive structure, and the front-back drive structure comprises:
a first transmission gear, rotatably fixed to a side wall of the cover plate in the left-right direction along an axis in the left-right direction and meshed with the first drive gear;
a second transmission gear, rotatably fixed to a side wall of the base plate in the left-right direction along the axis in the left-right direction;
a third transmission gear, coaxially connected to the second transmission gear;
a second drive gear, rotatably mounted at a side wall of the base plate along the axis in the left-right direction and meshed with the third transmission gear; and
a longitudinal limit structure, configured to limit a movement of the first movable plate in an up-down direction;
wherein a first drive groove is provided at the second drive gear, and the side wall of the movable plate in the left-right direction is protruded with a first drive boss configured to cooperate with the first drive groove; and
the first drive gear, the first transmission gear and the second transmission gear are meshed in sequence, and a number of teeth increases in sequence.

6. The motorized mechanism for translation adjustment according to claim 5, wherein the first drive groove is elliptical and is configured to extend radially along the second drive gear, and the second drive gear is a sector gear.

7. The motorized mechanism for translation adjustment according to claim 5, further comprising:
a synchronous transmission device,
wherein the synchronous transmission device comprises:
a bracket fixedly connected to the cover plate;
a guide rod configured to extend in the left-right direction and rotatably provided at the bracket;
a first synchronous gear provided at one end of the guide rod and meshed with the second drive gear;
a second synchronous gear provided at the other end of the guide rod; and
a third drive gear, rotatably mounted at the other side wall of the base plate and meshed with the second synchronous gear,
wherein the third drive gear is provided with a second drive groove, and a second drive boss configured to cooperate with the second drive groove is provided to protrude from the other side wall of the movable plate in the left-right direction.

8. The motorized mechanism for translation adjustment according to claim 5, wherein:
the movable plate further comprises a second movable plate, the second movable plate is movably provided between the first movable plate and the base plate in the left-right direction and is fixedly connected to the first movable plate;
the second movable plate is provided with a third drive boss protruding downward, and the third drive boss is provided with a left-right threaded hole along the left-right direction;
the stepper motor comprises a second stepper motor, the second stepper motor comprises a second output shaft configured to extend in the left-right direction, and a fourth drive gear is provided at the second output shaft; and
the drive structure further comprises a left-right drive structure, and the left-right drive structure comprises:
a lead screw, at least partially provided with threads and configured to cooperate with the threaded hole; and
a fifth drive gear sleeved at the lead screw and configured to drive the lead screw to rotate along the axis in the left-right direction;
wherein the fifth drive gear is meshed with the fourth drive gear through at least one transmission gear, and the lead screw is configured to drive the third drive boss to move in the left-right direction during rotation along the axis in the left-right direction.

9. The motorized mechanism for translation adjustment according to claim 8, wherein the base plate is provided with a limit hole in the up-down direction, the limit hole is configured to extend in a front-back direction, and a limit boss is provided to protrude from a bottom surface of the movable plate in the up-down direction to cooperate with the limit hole.

10. The motorized mechanism for translation adjustment according to claim 8, wherein the base plate is formed with a limit groove extending in the left-right direction corresponding to the third drive boss, and the third drive boss is provided in the limit groove.

11. The motorized mechanism for translation adjustment according to claim 1, wherein an upper end surface of the base plate is provided with a positioning column protruding upward, and a threaded hole is provided in an upper end surface of the positioning column along an up-down direction and is threaded to the cover plate.
